(19) United States
(12) Patent Application Publication
(10) Pub. No.: US 2020/0001918 A1
(43) Pub. Date: Jan. 2, 2020

(54) METHOD AND SYSTEM FOR STEERING WHEEL ASSEMBLIES FOR CRANES

(71) Applicant: CIMOLAI TECHNOLOGY SPA, Carmiganno Di Brenta (IT)

(72) Inventor: Donato CECCHIN, Galliera Veneta (IT)

(21) Appl. No.: 16/465,435

(22) PCT Filed: Nov. 30, 2016
(86) PCT No.: PCT/IT2016/000282

§ 371 Date: May 30, 2019

(51) Int. Cl. B62D 7/02; B62D 7/15

(52) U.S. Cl. CPC B62D 7/026; B66C 19/005; B62D 7/1509

(57) ABSTRACT

A method for steering the wheel assemblies of a gantry crane,
including the steps of beginning the steering of at least one wheel assembly in the desired direction;
and setting the angular position of a moveable pointer indicating a theoretical position of the wheel assembly which is consistent with said desired direction. The following steps are also included:
   setting an increment value of the moveable pointer in a direction consistent with respect to the steering movement of the wheel assembly;
   calculating the angular difference between the angular position of the moveable pointer and the current position of the wheel assembly;
   and—increasing the increment value of the moveable pointer if the difference shows a decrease, or decreasing the increment value of the moveable pointer if the difference shows an increase.

### TECHNICAL FIELD

The present disclosure is related to the field of steering for industrial cranes, in particular, in the field of steering for wheel assemblies of gantry cranes for naval or civil use or for watercraft hoists.

### BACKGROUND

Steering systems for industrial cranes such as for example gantry cranes are generally well known. A gantry crane is a large machine, capable of lifting objects. A gantry crane is generally used for lifting and transporting large cargo containers to and from railroad cars, trucks and other vehicles, cement manufactured articles, as well as for lifting and transporting watercraft.

Gantry cranes consist generally of a four-sided steel-framed structure, having vertical legs extending upward from wheel assemblies arranged at the four corners of the structure and ending in an upper frame structure connected to the vertical legs. The machine is completed by a lifting assembly, an engine, a user interface, and a control system for driving, which serves both to turn the wheels and to control the machine's lifting and movement capabilities.

The machine is driven by an operator, who utilizes the steering system to guide the crane in the operational area.

In some operational areas, the containers are stacked in columns. In these cases, all the wheel assemblies of the crane are positioned parallel to each other and the crane is simply moved in linear directions, parallel to the rows of containers.

In general, however, it is often necessary to move the crane in different directions than movement on parallel straight lines. In particular, it is often necessary to have a gantry crane that is capable of moving in different directions and of circulating with no specific restrictions within an operational area.

In this case, the gantry crane is necessarily provided with wheel assemblies of the steerable type.

Depending on the type of movement that it is desired to make the crane perform, each wheel assembly may be steered, i.e. rotated on a horizontal plane substantially parallel to the ground and about its own vertical axis, independently of the other wheel assemblies. This makes it possible to accomplish different types of movement and steering of the crane proper.

As far back as the 1990s gantry cranes were available on the market which had wheel assemblies that could steer independently, thus achieving wheel rotation movements that made it possible both to steer the crane to the right or to the left as normal, and also to perform particular movements, such as the “crab steering” movement, or the carousel rotary movement in which the crane substantially rotates about its own central vertical axis.

One of the problems that most afflicts the steering of the wheel or of the wheel assembly, understood as rotation in the clockwise or anticlockwise direction with respect to the vertical axis, is represented by the difficulty of defining and maintaining the best rotation speed on the horizontal plane of each wheel or wheel assembly, in order to minimize the time necessary to complete the correct angular positioning of each wheel or wheel assembly.

In fact, since gantry cranes are structures that weigh many tons, the effort necessary to steer a wheel assembly subjected to the pressure exerted by the weight of the structure is particularly high and requires the application of an adequate force. Such force is provided by the engine of the crane, which makes it possible to apply, on each wheel assembly, the necessary hydraulic pressure in order to rotate the assembly.

For this reason, in order to determine the angular rotation speed that can be imparted to a wheel assembly and in order to verify, during steering, that the wheel assembly is rotating correctly about its own vertical axis, often reference is made to a parameter derived directly from the operation of the engine.

For example, U.S. Pat. No. 7,252,299 discloses a steering system for a gantry crane in which the engine RPM is monitored in order to set the rotation speed of the wheel assemblies.

However, these methods based on the monitoring of parameters directly derived from the engine have several drawbacks.

In fact, the speed of steering of each wheel assembly is preset depending on the engine number of revolutions (RPM) detected, setting a speed of steering of the wheel or of the wheel assembly that is considered compatible with the engine RPM. This requires a possibly significant test activity on each specific machine, so as to define a rotation speed that is adequate and sustainable for the detected engine RPM.

This rotation speed must be set conservatively, since the environmental conditions under which the machine is made to operate, for example the nature or conditions of the ground, can have an influence on the effective capacity of the wheel assembly to perform a rotation on its own vertical axis in the preset times, thus making it effectively impossible to operate the rotation of the assemblies at the maximum speed that could theoretically be applied.

Furthermore, synchronization of the movements of the wheel assemblies for those steering manoeuvres of the gantry crane that require a synchronized movement of the wheel assemblies is also complex. In particular, when an error is detected that has slowed the rotation of one wheel assembly with respect to the others, the stoppage of the remaining wheel assemblies is required, in order to wait for the wheel assembly that fell behind to make up the lost rotation angle until it is realigned with the remaining wheel assemblies.

### SUMMARY

The aim of the present disclosure is to devise a system for steering a crane and for rotating the wheel assemblies that makes it possible to improve the state of the art.

The present disclosure provides a system that makes it possible to maximize the speed of steering of each wheel assembly.

Within this aim, the present disclosure relates to providing a system that does not require the setting or monitoring of the engine RPM in order to perform the steering of the wheel assemblies.

The present disclosure also provides a system that makes it possible to maximize the speed of steering of a crane, i.e. to minimize the time necessary in order to bring each wheel assembly of the crane into the position that it must assume in order to enable the crane to perform the steering movement required.

The present disclosure further provides a system of rotation of a wheel assembly that can be applied independently of the type of steering required, be it conventional left/right steering, or carousel rotary steering, or “crab steering”.

### Disclosure

This aim and these and other advantages which will become better apparent hereinafter are achieved by providing a method of steering for wheel assemblies of a gantry crane, the method comprising the steps of: beginning the steering of at least one wheel assembly in the desired direction; setting the angular position of a moveable pointer indicating a theoretical position of said wheel assembly which is consistent with said desired direction; iterating the steps that include: setting an increment value of said moveable pointer in a direction consistent with respect to the steering movement of said wheel assembly; calculating the angular difference between the angular position of the moveable pointer and the current position of the wheel assembly; increasing the increment value of said moveable pointer if said difference shows a decrease, or decreasing the increment value of said moveable pointer if said difference shows an increase.

The aim and advantages are also achieved by providing a steering system for wheel assemblies of a straddle carrier, which comprises a steering controller configured for: beginning the steering of at least one wheel assembly in the desired direction; setting the angular position of a moveable pointer indicating a theoretical position of said wheel assembly which is consistent with said desired direction; iterating the steps that include: setting an increment value of said moveable pointer in a direction consistent with respect to the steering movement of said wheel assembly; calculating the angular difference between the angular position of the moveable pointer and the current position of the wheel assembly; varying the speed of the increment value of said moveable pointer, increasing it or decreasing it if said difference respectively shows a decrease or shows an increase.

The increment value of the moveable pointer is preferably limited between a minimum increment value, which can also be nil, and a maximum increment value.

The wheel assemblies may comprise only one wheel per assembly or more than one wheel per assembly. In a same gantry crane/straddle carrier, there may be wheel assemblies provided with a different number of wheels with respect to each other.

Control of steering of the wheels or of the wheel assemblies may be performed simultaneously on multiple wheels or on multiple wheel assemblies. The steering of each wheel or wheel assembly may occur synchronously, asynchronously or partially synchronously between the various wheels and wheel assemblies, according to requirements.

### BRIEF DESCRIPTION OF THE DRAWINGS

Further characteristics and advantages of the disclosure will become better apparent from the detailed description of a preferred, but not exclusive, embodiment of a system of rotation of a wheel assembly of a crane according to the disclosure, which is illustrated for the purposes of non-limiting example in the accompanying drawings wherein:

FIG. 1 is a side view of a gantry crane according to the present disclosure;

FIG. 2 is a plan view of the crane of FIG. 1;

FIG. 3 is a front elevation view of the crane of FIG. 1;

FIG. 4 is a schematic block diagram of the steering system for cranes of FIG. 1;

FIGS. 5 to 8 illustrate different positions of the wheel assemblies in steering cycles of the gantry crane of FIG. 1; and

FIG. 9 is a flowchart that shows a method of steering according to the present disclosure.

### DETAILED DESCRIPTION OF THE DRAWINGS

This description generally relates to a method and a system for steering a crane supported by wheels, including cranes for ship and watercraft, cement manufactured articles, or generic loads. The method and steering system described herein may be also used in other types of cranes.

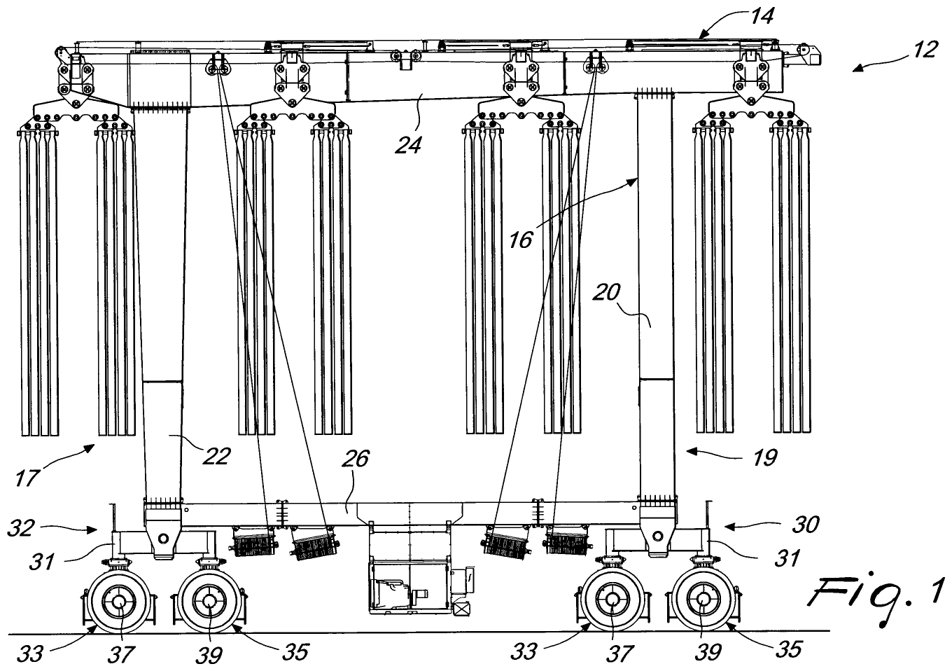

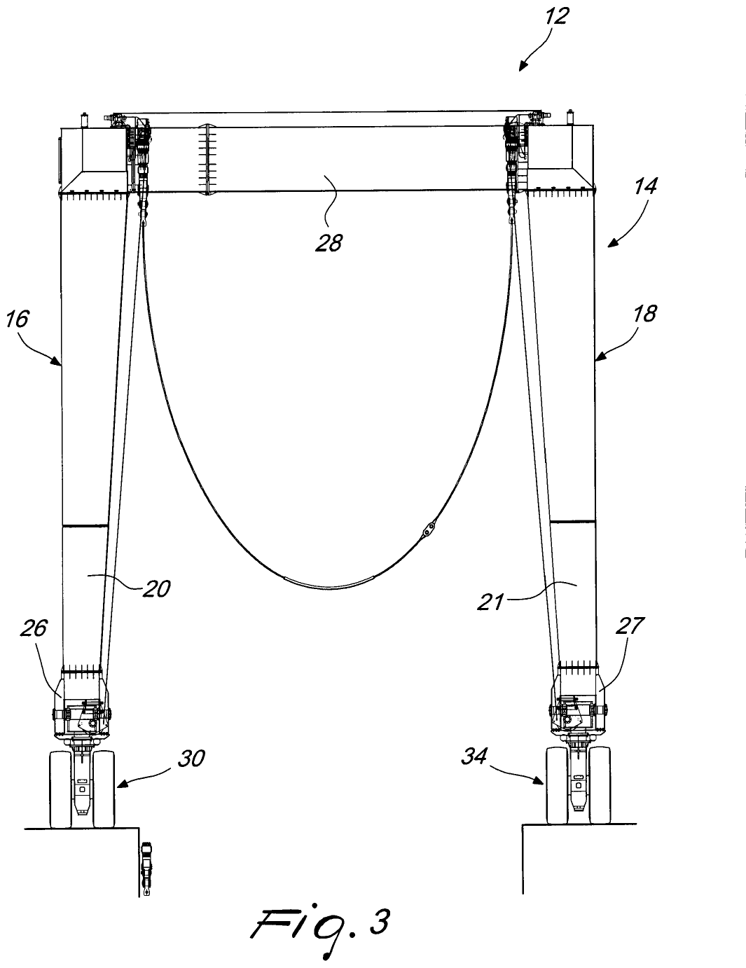

FIGS. 1 to 3 illustrate a gantry crane 12 provided with a steering system 10. The gantry crane 12 of FIG. 1 shows a gantry crane of the type used for lifting and moving boats.

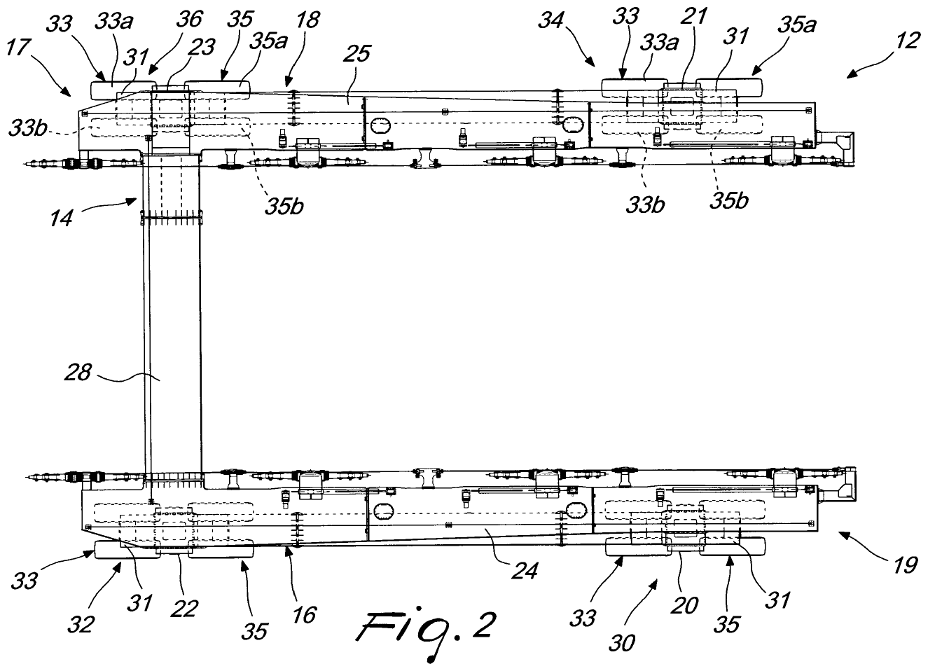

The gantry crane 12 generally includes a gantry structure 14. The gantry structure 14 has a support frame 16 on the first side and a support frame 18 on the second side. In an embodiment, the terms “first side” and “second side” represent respectively the left and right sides of the gantry crane 12. It is to be understood that the references to the “right” and “left” sides is from the perspective of the gantry crane 12 in FIG. 2.

In an alternative embodiment, the terms “first side” and “second side” represent the right and left sides of the gantry crane 12. The first side support frame 16 and the second side support frame 18 are substantially identical for the purposes of this description.

An upper cross beam 28 extends between the first side support frame 16 and the second side support frame 18, and connects the first side support frame 16 and the second side support frame 18. The upper cross beam 28 connects one end of the first side support frame 16 to a corresponding end of the second side support frame 18.

The upper cross beam 28 may be adjustable. In an embodiment, the upper cross beam 28 may include a flanged joint or other structure to allow for adjusting the length of the upper cross beam 28, and thus the width of the gantry crane 12.

The gantry structure 14 has a front portion 17 and a rear portion 19. The upper cross beam 28 is located at the front portion 17. It is to be understood that the terms “front” and “rear” define the ends of the gantry crane 12. In a crane without a clear distinction between such ends, the terms can be assigned indifferently to a respective end.

The first side support frame 16 comprises a first side rear column 20, a first side front column 22, a first side upper cross beam 24 and a first side lower cross beam 26. The first side upper cross beam 24 and the first side lower cross beam 26 extend between the first side rear column 20 and the first side front column 22. The first side upper cross beam 24 and the first side lower cross beam 26 connect the first side rear column 20 to the first side front column 22.

A first side rear wheel assembly 30 is positioned at the rear portion 19 of the gantry crane 12. The first side rear wheel assembly 30 is located adjacent to a lower end of the first side rear column 20. The first side front wheel assembly 32 is positioned at the front portion 17 of the gantry crane 12. The first side front wheel assembly 32 is located adjacent to a lower end of the first side front column 22.

The second side support frame 18 comprises a second side rear column 21, a second side front column 23, a second side upper cross beam 25 and a second side lower cross beam 27. The second side upper cross beam 25 and the second side lower cross beam 27 extend between the second side rear column 21 and the second side front column 23. The second side upper cross beam 25 and the second side lower cross beam 27 connect the second side rear column 21 to the second side front column 23.

A second side rear wheel assembly 34 is positioned at the rear portion 19 of the gantry crane 12. The second side rear wheel assembly 34 is located adjacent to a lower end of the second side rear column 21. A second side front wheel assembly 36 is positioned at the front portion 17 of the gantry crane 12. The second side front wheel assembly 36 is located adjacent to a lower end of the second side front column 23.

The wheelbase of the gantry crane 12 is the distance between the rear wheel assemblies 30, 34 and the front wheel assemblies 32, 36. The width of the gantry crane 12 is the distance between the first side lateral wheels 30, 32 and the second side wheels 34, 36.

In an embodiment, each wheel assembly 30, 32, 34, 36 comprises a bogie frame 31 having two tandem wheel pairs 33, 35. Each bogie frame 31 is mounted at the lower end of a respective column 20, 21, 22, 23.

Each bogie frame 31 is rotatable about a rotation axis. In an embodiment, the rotation axis coincides with the vertical axis of the respective column 20, 21, 22, 23. Each wheel pair may have an outer wheel 33a, 35a and an inner wheel 33b, 35b.

In a further embodiment, one wheel in a wheel pair 33, 35 is a drive wheel, while the other is an idle wheel.

The wheels 33a, 33b and 35a, 35b of the wheel pairs 33 and 35 are placed on both sides of the axles 37 and 39 and extend downward from the bogie frame 31. The wheels 33a, 33b and 35a, 35b are mounted on bearings at the lower ends of the axles 37 and 39. The wheels 33a, 33b and 35a, 35b are mounted on the sides of the axles 37 and 39. In an embodiment, the wheels 33a, 33b and 35a, 35b rotate with the axles 37 and 39 about their vertical axes. The wheels 33a, 33b and 35a, 35b may be offset from the vertical axes.

The wheel assembly is rotational about a rotation axis. In an embodiment, the rotational axis coincides with the vertical axis of the axle. In an alternative embodiment, each wheel assembly 30, 32, 34, 36 comprises a single wheel. Each wheel is mounted on bearings at the lower end of an axle that is connected to respective column 20, 21, 22, 23. Each wheel 30, 32, 34, 36 may be independently controlled. Each wheel 30, 32, 34, 36 is rotatable about a rotation axis.

In an embodiment, the rotation axis coincides with the vertical axis of the axle. The rotation axis and/or the vertical axis of the axle intersects the wheel.

The steering system 10 for the gantry crane 12 comprises front wheel assemblies 32, 36 connected proximate to a front portion 17 of the gantry crane 12, the front wheel assemblies 32, 36 comprising a first side front wheel assembly 32 and a second side front wheel assembly 36; rear wheel assemblies 30, 34 connected proximate to a rear portion 19 of the gantry crane 19, the rear wheel assemblies 30, 34 comprising a first side rear wheel assembly 30 and a second side rear wheel assembly 34.

The steering system 10 furthermore comprises a control system connected to the gantry crane 12 having a user interface operably connected for controlling the direction of the gantry crane 12, and a programmable steering controller for controlling the angular position of each wheel 30, 32, 34, 36, in order to impose or effect a steering mode selected through the user interface.

A concentric rotary movement may be comprised among the steering modes.

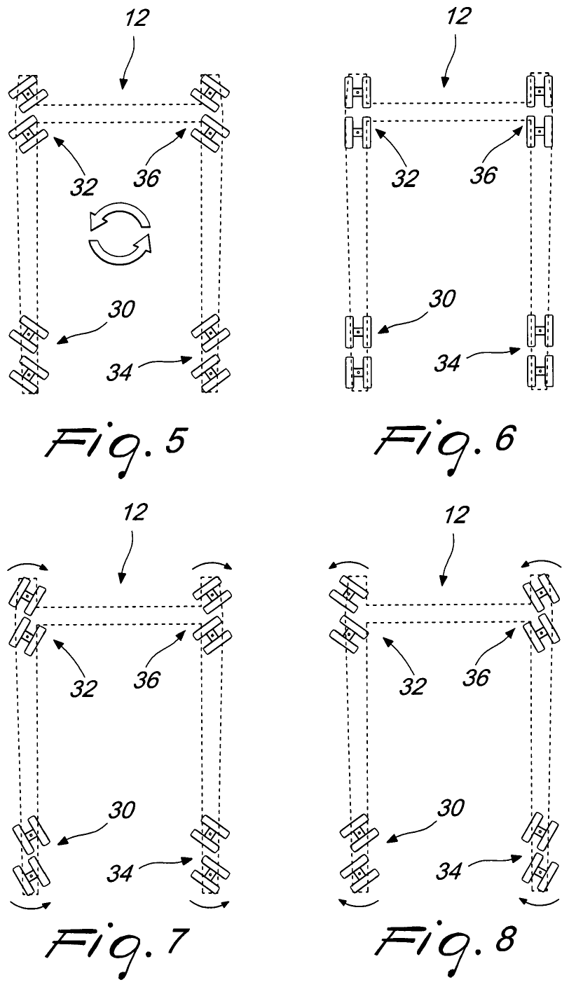

The concentric rotary steering mode enables the gantry crane 12 to perform a standing rotation. In the concentric rotary steering mode the gantry crane 12 moves to standing rotation through a linear path. FIG. 5 illustrates a standing rotation of the gantry crane 12.

FIG. 6 shows an initial position of the gantry crane 12, to which reference will be made for the sake of simplicity of explanation, with all the wheels and the wheel assemblies 30, 32, 34, 36 arranged at 0°, i.e. arranged parallel to the longitudinal axis of the gantry crane 12.

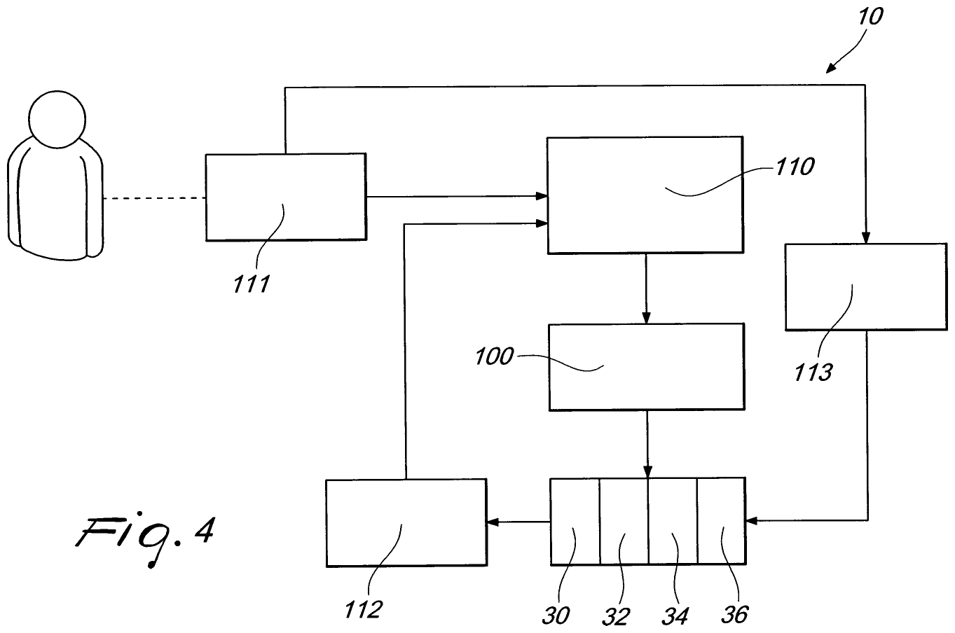

With reference to FIG. 4, the steering system 10 is configured and programmed to monitor and control the position of the wheel assemblies 30, 32, 34, 36. The steering system 10 furthermore comprises: a programmable controller or steering controller 110; a hydraulic assembly 100 controlled by the programmable controller 110, a user or operator interface 111, and a plurality of sensors 112. The programmable controller 110 is programmed to accommodate the various steering modes and safety functions described herein. The gantry crane has a drive engine for its movement. The rotation of the engine makes it possible to actuate the wheel assemblies 30, 32, 34, 36. The steering system 10 is coupled to the drive engine.

Each wheel assembly 30, 32, 34, 36 is coupled to a respective hydraulic assembly 100. The hydraulic assembly 100 is operably connected to the steering system 10. Each hydraulic assembly receives control or steering signals from the steering system 10 and consequently rotates the respective wheel assembly 30, 32, 34, 36 to bring it to a required position. The rotation of the wheel assemblies is controlled by a programmable steering controller 110. The hydraulic assembly 100 comprises a hydraulic motor with a pinion drive gear. Other steering systems, known in the art, may also be used for steering the wheels. For example, a hydraulic cylinder system with appropriate linkages may be used in place of the hydraulic motor and pinion drive gear.

The steering system 10 enables the gantry crane 12 to be driven as required within an operational area. The steering system 10 enables steering in a four-wheel mode in which all the wheel assemblies 30, 32, 34, 36 are engaged to move the gantry crane 12.

The gantry crane 12 is capable of performing a standing rotation in which the gantry crane turns about a central axis. In standing rotation, the gantry crane 12 has a substantially zero turning radius.

A method of effecting steering in a gantry crane having wheel assemblies 30, 32, 34, 36 will now be described.

The gantry crane 12 is moved under the effect of the drive engine, which actuates the rotation and the steering of the wheel assemblies 30, 32, 34, 36.

In order to illustrate the steering method and system according to the present disclosure, reference will be made below to a simplified embodiment of a gantry crane 12, in which each wheel assembly 30, 32, 34, 36 comprises only one wheel. The person skilled in the art will understand without effort how to apply this system and method to wheel assemblies that comprise more than one wheel.

Each wheel assembly 30, 32, 34, 36 may be actuated by a hydraulic or electric actuator, for example a motorized center bearing or a hydraulic cylinder.

The rotation of the wheel assembly 30, 32, 34, 36 is driven through the programmable controller 110, which may correspond to or be comprised in the general PLC of the machine.

Means are furthermore provided for controlling the actual position of each wheel 30, 32, 34, 36. In an embodiment, such means can be in the form of a multi-turn absolute encoder, capable of restoring the effective angular position of each wheel 30, 32, 34, 36.

The programmable controller 110 is programmed or configured to calculate the theoretical position of each wheel 30, 32, 34, 36 as a function of the steering cycle selected.

When the operator actuates the means of actuation of the gantry crane 12, for example in the form of a joystick, which may be moved to the right or to the left, the controller 110 increases or decreases the position of a moveable pointer.

Changing the theoretical value of the position of the moveable pointer generates a relative difference or error, “ER”, between this value and the actual position of a corresponding wheel 30, 32, 34, 36.

The controller 110 therefore generates a command signal to rotate the wheels 30, 32, 34, 36 clockwise or anticlockwise so as to try to cancel out the position difference ER that exists between the theoretical angular position of the wheel indicated by the moveable pointer and the current angular position of the wheel, in order to move the wheel exactly to the current position of the moveable pointer.

The steering controller 110 is configured to adjust the speed of the moveable pointer as a function of the effective rotation speed of the wheel 30, 32, 34, 36.

The speed of the wheel 30, 32, 34, 36 is, in turn, proportional to the availability of the hydraulic oil supplied by the pump that feeds the circuit.

During the rotation movement, the smaller the difference ER, the more the speed of movement of the moveable pointer can be increased. In fact, a low relative difference ER indicates to the controller 110 that the wheel 30, 32, 34, 36 is rotating with a speed that is adequate but slower than the theoretical speed it could sustain.

In particular, a decrease in the difference between the value of the moveable pointer and the current position of the wheel 30, 32, 34, 36 during the steering movement indicates that the current speed of steering of the wheel is effectively faster than the theoretical speed currently required by the increase of the moveable pointer.

The steering controller 110, once it has detected this situation, can therefore increase the speed of the moveable pointer until the rotation speed of the wheel is capable of compensating the relative difference in position ER, optionally keeping this difference within a preset window.

When the steering controller 110 detects that the relative difference ER begins to increase, it then understands that the wheel 30, 32, 34, 36 has reached its maximum rotation speed under the specific conditions of use in which the wheel 30, 32, 34, 36 is operating.

Such conditions of use can depend on the flow-rate of oil in the hydraulic circuit, on the steering configuration selected, on the number of wheels being steered and on the environmental conditions, in particular on the conditions of the asphalt or of the surface on which the gantry crane 12 is being moved.

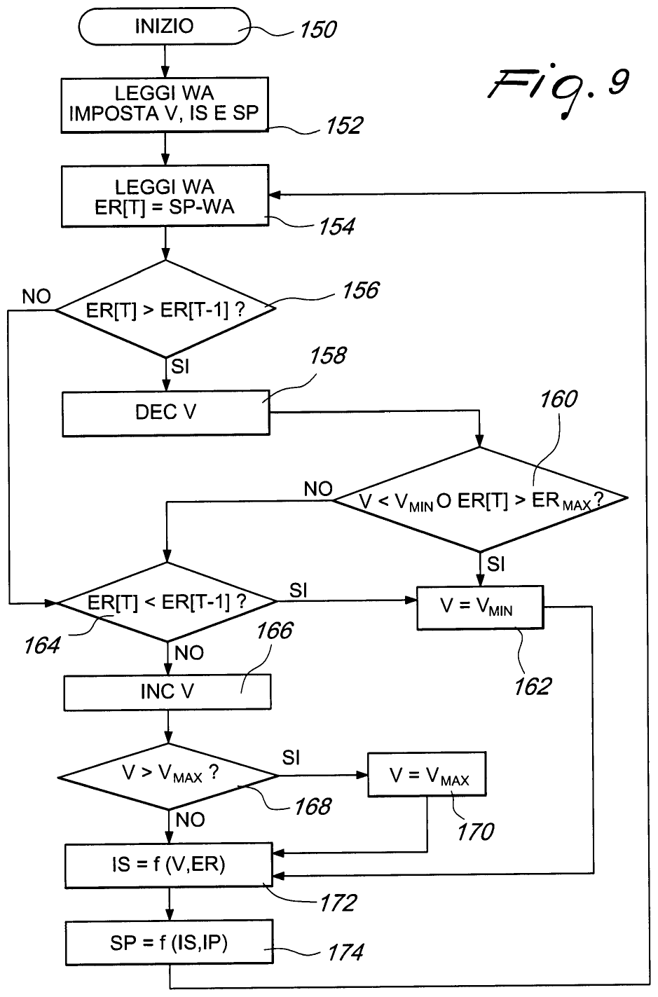

FIG. 9 is a flowchart that better illustrates the programming of the steering controller 110, and this will now be described with reference to the following configurations or adjustment parameters which are described below for the purposes of example.

In step 150, the procedure of steering a wheel 30, 32, 34, 36 is begun following a command imparted by the operator. For example, the operator imparts a steering command that requires the wheel 30, 32, 34, 36 to steer in the clockwise direction.

In step 152, the steering controller 110, after having detected the current angular position WA of the wheel, sets an increment step value IS of such angular position, on the basis of a steering speed parameter V which is considered suitable for steering the wheel clockwise. The controller 110 furthermore sets the moveable pointer, or set point SP of the wheel 30, 32, 34, 36 to an initial value different from the value WA, which identifies an angular position corresponding to a clockwise rotation of such wheel.

In step 154 the iterative cycle of steering the wheel 30, 32, 34, 36 begins. The steering controller 110 detects the actual angular position WA of the wheel 30, 32, 34, 36 and calculates the difference between the value of the moveable pointer, or set point SP, indicating a theoretical position of the wheel 30, 32, 34, 36, and the current value WA, indicating the actual position of the wheel 30, 32, 34, 36.

In step 156, the steering controller 110 checks if the difference ER at the current time T, ER[T], is greater than the difference ER[T−1], i.e. the difference found in the previous cycle, at time T−1.

In the affirmative, if ER[T] is greater than ER[T−1], in step 158 the steering controller slows the speed V of increase of the moveable pointer, since the increase of the angular difference between the moveable pointer and the position of the wheel indicates that the wheel 30, 32, 34, 36 is steering more slowly than the theoretical speed required by the moveable pointer.

In step 160, the steering controller 110 then checks that the speed V of the moveable pointer, thus decreased, is not less than a minimum value V_{MIN}, in which case the value V is set to be equal to V_{MIN} in step 162. V_{MIN} is a parameter that limits the speed of increase of the moveable pointer with regard to the lower limit. This parameter, if positive, acts to keep the movement of the wheel 30, 32, 34, 36 fluid, thus preventing it from stopping, and can correspond to the minimum speed of steering of the wheel 30, 32, 34, 36. In an embodiment the parameter can in any case be nil.

Similarly, in the same step 160 the steering controller 110 checks whether the current difference ER[T] between the angular position SP of the moveable pointer and the actual angular position WA of the wheel 30, 32, 34, 36 is higher than a maximum value ER_{MAX}. If it is, in this case too the speed value V of the moveable pointer is set equal to V_{MIN} in step 162.

In step 164, the steering controller 110 checks if the difference ER[T] is less than the difference ER[T−1] detected in the previous cycle. In the affirmative, the steering controller 110 then, in step 166, increases the speed V of the moveable pointer SP, since the decrease of the angular difference ER between the moveable pointer SP and the position WA of the wheel 30, 32, 34, 36 indicates that the wheel is steering faster than the speed required by the moveable pointer.

In step 168, the steering controller checks that the speed V of the moveable pointer, thus increased, is not more than a maximum value V_{MAX}, in which case the value V is set to be equal to V_{MAX} in step 170.

In step 172, the steering controller determines the new steering increment value IS of the moveable pointer as a function of the values of V and of ER, for example according to the formula:

IS=V_{MAX}−(V_{MAX}−V_{MIN})*ER/E_{MAX}.

The cycle then moves to step 174, where a new value of the moveable pointer SP is set as a function of IS and of IP, for example calculated according to the formula SP=IS*IP, where IP is a parameter indicating a value in degrees as a function of which the controller determines the value that is added to or subtracted from the moveable pointer SP in order to produce the new theoretical position of the wheel.

At this point the cycle resumes at step 154 and proceeds until the gantry crane 12 has reached the desired position.

In an embodiment, two multiplication parameters, KPN and KPNR, are furthermore used. In an embodiment, the first parameter KPN is a multiplication constant used when the moveable pointer SP is in a negative field. The function of this constant is to reduce the speed V of the moveable pointer SP, when, according to the geometry of the machines 12, a wheel 30, 32, 34, 36 that steers in the negative quadrant has to travel a smaller circular arc than a wheel 30, 32, 34, 36 that steers in the positive quadrant.

The second parameter KPNR includes an additional multiplication constant that further reduces the speed V of the moveable pointer SP, when, according to the geometry of the machines 12, a wheel 30, 32, 34, 36 that steers in the negative quadrant has to travel a smaller circular arc than a wheel 30, 32, 34, 36 that steers in the positive quadrant. This parameter is linked to the exceeding of a determined negative angle that can be set with the aim of making fluid and symmetrical the movement in the two quadrants, positive and negative, including at the steering endpoints, where the geometries of the machines 12 can imply a strong divergence between the angles SP calculated by the controller for each wheel assembly 30, 32, 34, 36.

In an embodiment, more corrective constants, KPN and KPNR, are furthermore used and are associated with each steering cycle or with groups of steering cycles, so as to be able to better optimize the response of the movement and the driveability of the crane.

A second group of parameters KP1-2 and KP3-8 can include a series of multiplication constants that increase the speed V of the moveable pointer SP in order to make the steering movement more dynamic when a steering cycle is used that involves a smaller number of wheels 30, 32, 34, 36 than the total number of wheels, for example 2 out of 4 or 4 out of 8.

The cycle described above for example with reference to the steering of a wheel 30, 32, 34, 36 applies in fact to steering modes that comprise the simultaneous rotation of different wheel assemblies.

The operator can select, typically by way of the control means, a desired type of steering, which can include for example: steering of the gantry crane to the right or to the left, independently of the advancement direction of the crane (forward, backward, to the side); crab steering; carousel steering.

In each one of these types of steering, each wheel 30, 32, 34, 36 or wheel assembly of the gantry crane 12 must reach a suitable final angle. In some cases, such as for example in the case of carousel steering, the final steering angle of each wheel 30, 32, 34, 36 is preset.

It is therefore necessary to have an at least partially synchronized movement between the various wheel assemblies and/or the various wheels of the wheel assemblies. If the wheels of a wheel assembly are independent of each other, it is possible that each wheel 30, 32, 34, 36 can be steered at a different angle from the other wheel or wheels of the same wheel assembly.

In an embodiment, if a type of steering is selected, the steering controller 110 can set a target position for each wheel and/or wheel assembly 30, 32, 34, 36. In this case, the movement of each wheel or wheel assembly can be actuated and controlled automatically by the steering controller 110 until the target position of each wheel 30, 32, 34, 36 is reached.

The following explanation is given for the purposes of example with reference to the positioning of the wheel assemblies or of the wheels 30, 32, 34, 36 for a rotation mode of the type known as carousel steering, in which all the wheel assemblies must be positioned so as to allow the crane 12 to rotate in place, mentioning further exemplary components of a possible embodiment in the description.

After having selected and enabled the carousel drive mode, the operator actuates the control means by inclining, for example, the steering joystick to the right or left according to requirements. The gantry crane 12 begins to move. In particular, the wheel assemblies 30, 32, 34, 36 begin to steer, each one according to the value of the respective moveable pointer as set by the steering controller 110.

For each wheel or wheel assembly to be turned, the moveable pointer may increase or decrease with a variable speed, as explained with reference to the method of steering illustrated above with reference to a single wheel.

For a square vehicle, the wheel assemblies 30, 32, 34, 36 must rotate up until a position that is concentric with respect to the vertical rotation axis of the crane 12, in particular up until it reaches an angular position substantially equal to ±45° with respect to an initial position with the wheels 30, 32, 34, 36 all aligned with each other.

FIG. 7 illustrates a gantry crane 12 in a carousel steering mode to the right. The first direction of steering, of the front wheel assemblies 32, 36, is the clockwise direction. The second direction of steering, of the rear wheel assemblies 30, 34, is the anti-clockwise direction. The first rotational speed, of the first side wheel assemblies 30, 32, is less than the second rotational speed, of the second side wheel assemblies 34, 36.

The first side front wheel assembly 32 must steer until the 45° target angular position is reached, the second side front wheel assembly 36 must steer until the 135° target angular position is reached, the first side rear wheel assembly 30 must steer until the 45° target angular position is reached and the second side rear wheel assembly 34 must steer until the 135° target angular position is reached from the respective initial positions parallel to a longitudinal axis of the crane 12.

FIG. 8 illustrates a gantry crane 12 in a carousel steering mode to the left. The first direction of steering, of the front wheel assemblies 32, 36, is the anti-clockwise direction. The second direction of steering, of the rear wheel assemblies 30, 34, is the clockwise direction. The first rotational speed, of the first side wheel assemblies 30, 32, is greater than the second rotational speed, of the second side wheel assemblies 34, 36.

The first side front wheel assembly 32 must steer until the 135° target angular position is reached, the second side front wheel assembly 36 must steer until the 45° target angular position is reached, the first side rear wheel assembly 30 must steer until the 135° target angular position is reached and the second side rear wheel assembly 34 must steer until the 45° target angular position is reached from the respective initial positions parallel to a longitudinal axis of the crane 12.

Each wheel assembly 30, 32, 34, 36 can be controlled by an encoder that communicates with the programmable steering controller 110, for example via the PROFIBUS or PROFINET field bus. In this way, the programmable steering controller 110 is informed in real time of the position of each wheel 30, 32, 34, 36.

A proportional distributor for each wheel assembly 30, 32, 34, 36 sends oil to the hydraulic circuit of the hydraulic assembly 100, which powers the actuator that moves each wheel 30, 32, 34, 36.

The signal to the hydraulic distributor will be proportional and appropriately functionally modulated in the calculation of the positional data of each wheel 30, 32, 34, 36 as provided by the encoder, in particular as a function of the speed of movement, as a function of the pressure of the hydraulic pressure circuit according to the algorithms provided and executed by the processor of the programmable controller 110. For the rotation of the wheel assemblies 30, 32, 34, 36, electric drives and electric actuators can be used as an alternative to the hydraulic distributor and hydraulic actuators.

With reference to the above explanation about the steering of a single wheel or wheel assembly, for the simultaneous steering of multiple wheels or wheel assemblies which is necessary to place the gantry crane 12 in a position for carousel rotation, the steering controller 110 controls in real time the value ER of all the wheels and/or wheel assemblies 30, 32, 34, 36 using, in the calculation formulas given above, the highest value ER and adapting the movement to the wheel 30, 32, 34, 36 that is in a position farther from its theoretical position indicated by the value of the corresponding moveable pointer.

Both for carousel rotation and for the other steering cycles, the calculation of the steering increase IS for each wheel or wheel assembly 30, 32, 34, 36 can take into account the two multiplication parameters KPN and KP2R described above and the two parameters KP1-2 and KP3-8.

If, during steering, the difference in position between the value of the moveable pointer SP and the current value WA of the position of a wheel 30, 32, 34, 36 should exceed a maximum threshold, an alarm mechanism will stop the steering movement of all the wheels or wheel assemblies 30, 32, 34, 36 and any translation movement of the gantry crane 12.

In this case, the steering controller 110 can be configured, for example as a consequence of pressing a special command on the control means, to automatically return the wheel or the wheel assembly 30, 32, 34, 36 that is currently outside the maximum window to the correct position.

In the event of severe error, for example a high difference between the position of the moveable pointer SP and the actual position WA of the wheel, the steering controller 110 can be configured to completely shut down the gantry crane 12 in order to prevent damage.

The application of the method described above is entirely similar with reference to other steering cycles.

### INDUSTRIAL APPLICABILITY

The present discussion describes a steering system 10 for a gantry crane 12, with particular reference to the steering of each wheel or of each wheel assembly 30, 32, 34, 36.

It has been found that the method and the system thus conceived make it possible to provide an improved steering of a gantry crane with respect to conventional systems, for example with respect to systems based on monitoring a parameter of the drive engine of the gantry crane.

In particular, the method and the system described herein make it possible to provide the steering of the wheels or of the wheel assemblies of a gantry crane in faster times, since the speed of steering of each wheel or wheel assembly is adapted in real time to the maximum sustainable angular speed, and with a more fluid steering movement.

The system described herein includes all modifications and equivalents of the subject matter recited in the claims appended hereto as permitted by applicable law. Moreover, any combination of the above-described elements in all possible variations thereof is encompassed by this disclosure unless otherwise indicated herein.

Where technical features mentioned in any claim are followed by reference signs, the reference signs have been included for the sole purpose of increasing the intelligibility of the claims and accordingly, neither the reference signs nor their absence have any limiting effect on the technical features as described above or on the scope of any claim elements.

The person skilled in the art will understand that what is disclosed herein may be embodied in other specific forms without departing from the disclosure or from the essential characteristics thereof. The foregoing embodiments are therefore to be considered in all respects illustrative rather than limiting of the disclosure described herein. The scope of the disclosure is thus indicated by the appended claims, rather than the foregoing description, and all changes that come within the meaning and range of equivalence of the claims are therefore intended to be embraced therein.

1-10. (canceled)

11. A method of steering for wheel assemblies of a gantry crane, the method including the following steps:
a) beginning a steering of at least one wheel assembly in a desired direction;
b) setting an angular position of a moveable pointer indicating a theoretical position of said wheel assembly which is consistent with said desired direction; and
c) iterating the following steps:
setting an increment value of said moveable pointer in a direction consistent with respect to the steering movement of said wheel assembly;
calculating an angular difference between the angular position of the moveable pointer and a current position of the wheel assembly; and
increasing the increment value of said moveable pointer if said angular difference shows a decrease, or decreasing the increment value of said moveable pointer if said angular difference shows an increase.

12. The method according to claim 11, wherein said increment value is limited between a minimum increment value and a maximum increment value.

13. The method according to claim 11, wherein said wheel assemblies comprise only one wheel per assembly.

14. The method according to claim 11, wherein said wheel assemblies comprise more than one wheel per assembly.

15. The method according to claim 14, wherein it applies the steps from a) to c) on different wheels in said wheel assemblies.

16. A steering system for wheel assemblies of a gantry crane, which comprises a controller configured for:
a) beginning a steering of at least one wheel assembly in a desired direction;
b) setting an angular position of a moveable pointer indicating a theoretical position of said wheel assembly which is consistent with said desired direction; and
c) iterating the following steps:
setting an increment value of said moveable pointer in a direction consistent with respect to the steering movement of said wheel assembly;
calculating an angular difference between an angular position of the moveable pointer and a current position of the wheel assembly; and
increasing the increment value of said moveable pointer if said angular difference shows a decrease, or decreasing the increment value of said moveable pointer if said angular difference shows an increase.

17. The system according to claim 16, wherein said increment value is limited between a minimum increment value and a maximum increment value.

18. The system according to claim 16, wherein said wheel assemblies comprise only one wheel per assembly.

19. The system according to claim 16, wherein said wheel assemblies comprise more than one wheel per assembly.

20. The system according to claim 19, wherein the controller is configured for applying the steps from a) to c) on different wheels in said wheel assemblies.
